(19) United States
(12) Patent Application Publication
(10) Pub. No.: US 2025/0038265 A1
(43) Pub. Date: Jan. 30, 2025

(54) ELECTROLYTE FOR RECHARGEABLE LITHIUM BATTERY AND RECHARGEABLE LITHIUM BATTERY INCLUDING THE SAME

(71) Applicant: Samsung SDI Co., Ltd., Yongin-si (KR)

(72) Inventors: Youngkyeong SHIN, Yongin-si (KR); Tae Hyon BAE, Yongin-si (KR); Harim LEE, Yongin-si (KR); Sanghyung KIM, Yongin-si (KR); Seunghyeon SON, Yongin-si (KR); Arum YU, Yongin-si (KR); Sanghoon KIM, Yongin-si (KR)

(21) Appl. No.: 18/734,868

(22) Filed: Jun. 5, 2024

(30) Foreign Application Priority Data
Jul. 27, 2023 (KR) 10-2023-0098394

(51) Int. Cl. H01M 10/0567; H01M 4/02; H01M 4/525; H01M 4/583; H01M 10/052; H01M 10/0568; H01M 10/0569

(52) U.S. Cl. CPC H01M 10/0567; H01M 4/525; H01M 4/583; H01M 10/052; H01M 10/0568; H01M 10/0569; H01M 2004/027; H01M 2004/028; H01M 2300/004

(57) ABSTRACT

An electrolyte for a rechargeable lithium battery includes a lithium salt; a non-aqueous organic solvent; a first additive represented by Chemical Formula 1; and a second additive represented by Chemical Formula 2:

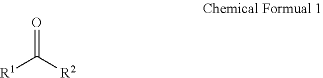

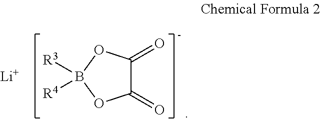

A rechargeable lithium battery includes a positive electrode including a positive electrode active material; a negative electrode including a negative electrode active material; and the electrolyte.

### CROSS-REFERENCE TO RELATED APPLICATION

The present application claims priority to and the benefit of Korean Patent Application No. 10-2023-0098394, filed on Jul. 27, 2023, in the Korean Intellectual Property Office, the entire content of which is incorporated herein by reference.

### BACKGROUND

### 1. Field

One or more embodiments of the present disclosure are directed toward an electrolyte for a rechargeable lithium battery and a rechargeable lithium battery including the same are disclosed.

### 2. Description of the Related Art

With a recent rapid spread of the use of electronic devices that utilize batteries, such as mobile phones, laptop computers, and/or electric vehicles, the demand for rechargeable batteries with relatively high energy density and relatively high capacity has been rapidly increasing. Accordingly, research and development to improve the performance of rechargeable lithium batteries is being actively pursued.

A rechargeable lithium battery includes a positive electrode and a negative electrode including an active material capable of intercalating and deintercalating lithium ions, and an electrolyte, and electrical energy is produced through oxidation and reduction reactions if (e.g., when) lithium ions are intercalated/deintercalated from the positive electrode and negative electrode.

One of the recent development directions for rechargeable lithium batteries has been to improve high-voltage and/or high-temperature characteristics. In related art, rechargeable lithium batteries may experience reduced cycle-life and/or increased resistance at relatively high voltage and/or relatively high temperature.

### SUMMARY

One or more aspects of embodiments of the present disclosure are directed toward an electrolyte that may be utilized for a rechargeable lithium battery and that improves high-voltage and/or high-temperature characteristics of a rechargeable lithium battery.

One or more aspects of embodiments of the present disclosure are directed toward a rechargeable lithium battery including the electrolyte.

Additional aspects will be set forth in part in the description which follows and, in part, will be apparent from the description, or may be learned by practice of the presented embodiments of the disclosure.

According to one or more embodiments of the present disclosure, an electrolyte that may be utilized for a rechargeable lithium battery includes a lithium salt; a non-aqueous organic solvent; a first additive represented by Chemical Formula 1; and a second additive represented by Chemical Formula 2:

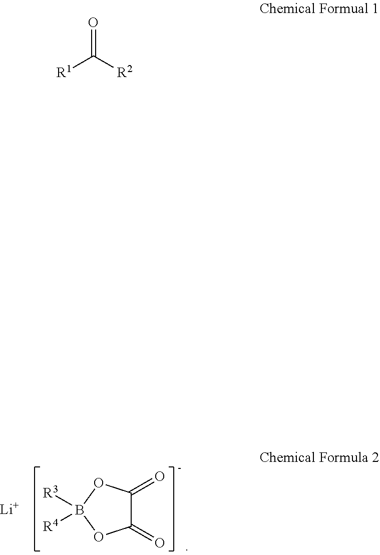

The electrolyte (e.g., for a rechargeable lithium battery) according to one or more embodiments can improve high-voltage and/or high-temperature characteristics of a rechargeable lithium battery.

### BRIEF DESCRIPTION OF THE DRAWINGS

These and/or other aspects will become apparent and more readily appreciated from the following description of the embodiments, taken in conjunction with the accompanying drawings in which:

FIGS. 1-4 are each a schematic view showing a rechargeable lithium battery according to one or more embodiments.

### DETAILED DESCRIPTION

Hereinafter, embodiments of the present disclosure will be described in more detail. However, these embodiments are examples, the present disclosure is not limited thereto and the present disclosure is defined by the scope of the appended claims and their equivalents.

As utilized herein, if (e.g., when) specific definition is not otherwise provided, it will be understood that if (e.g., when) an element such as a layer, film, region, or substrate is referred to as being “on” another element, it can be directly on the other element (e.g., without any intervening elements therebetween) or intervening elements may also be present.

As utilized herein, if (e.g., when) specific definition is not otherwise provided, the singular may also include the plural. In one or more embodiments, unless otherwise specified, “A or B” may refer to “including A, including B, or including A and B.”

As utilized herein, “a combination thereof” may refer to a mixture of constituents, a stack, a composite, a copolymer, an alloy, a blend, and/or a reaction product.

As utilized herein, the “active mass density of the negative electrode” is a value calculated by dividing a weight of the components (active material, conductive material, binder, and/or the like.) excluding the current collector in the negative electrode by a volume of the components.

As utilized herein, if (e.g., when) a definition is not otherwise provided, in chemical formulae, hydrogen is bonded at the position if (e.g., when) a chemical bond is not drawn where one is supposed to be given.

As utilized herein, “fluoroalkyl group” refers to an alkyl group in which one, some or all of the hydrogen atoms are replaced by fluorine atoms.

As utilized herein, “perfluoroalkyl group” refers to an alkyl group in which all hydrogen atoms are replaced by fluorine atoms.

It will be understood that, although the terms first, second, etc. may be used herein to describe various elements, these elements should not be limited by these terms. These terms are only used to distinguish one element from another element. Thus, a first element could be termed a second element without departing from the teachings of the present invention. Similarly, a second element could be termed a first element.

It will be further understood that the terms “includes,” “including,” “comprises,” and/or “comprising,” when used in this specification, specify the presence of stated features, steps, operations, elements, and/or components, but do not preclude the presence or addition of one or more other features, steps, operations, elements, components, and/or groups thereof.

As used herein, the terms “use,” “using,” and “used” may be considered synonymous with the terms “utilize,” “utilizing,” and “utilized,” respectively.

As used herein, expressions such as “at least one of”, “one of”, and “selected from”, when preceding a list of elements, modify the entire list of elements and do not modify the individual elements of the list. For example, “at least one selected from among a, b and c”, “at least one of a, b or c”, and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

As used herein, the term “and/or” includes any and all combinations of one or more of the associated listed items.

Further, the use of “may” when describing embodiments of the present disclosure refers to “one or more embodiments of the present disclosure”.

As used herein, the terms “substantially”, “about”, and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

### Electrolyte

Some embodiments provide an electrolyte for a rechargeable lithium battery including a lithium salt; a non-aqueous organic solvent; a first additive represented by Chemical Formula 1; and a second additive represented by Chemical Formula 2:

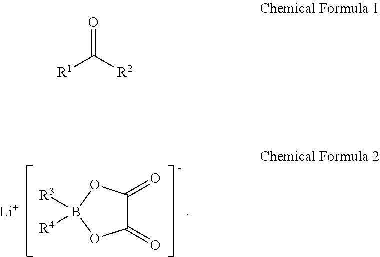

The first additive functions as a surfactant having both (e.g., simultaneously) hydrophilic and hydrophobic groups in one molecule.

The first additive includes a ketone group at the center and fluorine atoms and/or fluoroalkyl groups of 1 to 10 carbon atoms on both sides. Herein, the ketone group is a hydrophilic group, and the fluorine atom and/or fluoroalkyl group having 1 to 10 carbon atoms are each a hydrophobic group.

Accordingly, if (e.g., when) an electrolyte including the first additive is utilized, wettability of the positive electrode and negative electrode may be improved, lithium cation (Li⁺) may be uniformly (substantially uniformly) formed at the interface between the positive electrode and the electrolyte, and a suitably stable SEI film may be formed at the interface between the negative electrode and the electrolyte, thus suppressing or reducing the precipitation of lithium dendrites.

In one or more embodiments, the second additive is an oxalate borate compound substituted with a fluoro group, where the fluoro group is to suitably stabilize the lithium salt (e.g., LiPF₆).

Accordingly, if (e.g., when) an electrolyte including the second additive is utilized, production of HF may be suppressed or reduced, and transition metal elution from the positive electrode active material and/or damage to the SEI film at the interface between the negative electrode and the electrolyte may be prevented or reduced.

Therefore, if (e.g., when) an electrolyte including the first additive and the second additive is utilized, elution of transition metals from the positive electrode active material may be suppressed or reduced and a suitably stable SEI film may be formed on the negative electrode surface, thereby improving relatively high-voltage and/or relatively high-temperature characteristics of the rechargeable lithium battery.

Hereinafter, an electrolyte for a rechargeable lithium battery according to one or more embodiments will be described in more detail.

### First Additive

In Chemical Formula 1, R¹ and R² may each independently be a fluorine atom or a C1 to C10 fluoroalkyl group.

For example, R¹ may be a fluoroalkyl group or a perfluoroalkyl group having 2 carbon atoms.

In some embodiments, R² may be a fluoroalkyl group or a perfluoroalkyl group having 3 carbon atoms.

The first additive may be represented by Chemical Formula 1-1:

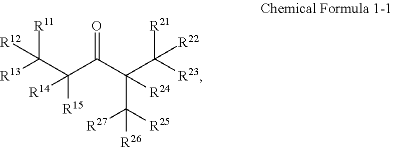

In Chemical Formula 1-1, R¹¹ to R¹⁵ are each a hydrogen atom or a fluorine atom, provided that at least one of R¹¹ to R¹⁵ is a fluorine atom; and R²¹ to R²⁷ are each a hydrogen atom or a fluorine atom, provided that at least one of R²¹ to R²⁷ is a fluorine atom.

Representative examples of the first additive are as follows:

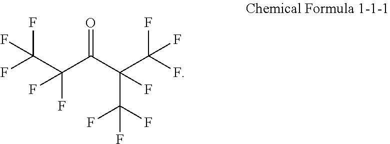 [SMILES: O=C(C(F)(F)C(F)(F)F)C(F)(C(F)(F)F)C(F)(F)F]

### Second Additive

In Chemical Formula 2, R³ and R⁴ may each independently be a halogen atom or a C1 to C10 fluoroalkyl group. Herein, the halogen atom may be a fluorine atom, a chlorine atom, a bromine atom, and/or an iodine atom.

For example, both R³ and R⁴ may be fluorine atoms (e.g., simultaneously).

Representative examples of the second additive are as follows:

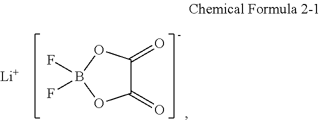

The second additive represented by Chemical Formula 2-1 is lithium difluoro(oxalato)borate (LiDFOB).

### Contents (e.g., Amounts) of First Additive and Second Additive

The first additive may be included in an amount of about 0.1 to about 10 wt %, about 0.5 to about 5 wt %, or about 1 to about 3 wt % based on a total amount of 100 wt % of the electrolyte.

If the first additive is included in excess of the above range, viscosity of the electrolyte including the first additive may increase excessively (or undesirably), and wettability of the positive electrode and the negative electrode may actually decrease. If the first additive is included in a small amount below the above range, the effect as a surfactant may be minimal or not suitable.

The second additive may be included in an amount of about 0.1 to about 5 wt %, about 0.3 to about 4 wt %, or about 0.5 to about 2 wt % based on the total amount of 100 wt % of the electrolyte.

If the second additive is included in excess of the above range, a side reaction may occur. If the second additive is included in a small amount below the above range, its effect may be minimal or not suitable.

A weight ratio of the first additive and the second additive may be about 1:5 to about 10:1, about 1:2 to about 5:1, or about 1:1 to about 4:1.

Within this range, the effects of the first additive and the second additive can be suitably harmonized.

### Non-Aqueous Organic Solvent

The non-aqueous organic solvent serves as a medium for transmitting ions taking part in the electrochemical reaction of a battery.

The non-aqueous organic solvent may be a carbonate-based solvent, an ester-based solvent, an ether-based solved, a ketone-based solvent, an alcohol-based solvent, an aprotic solvent, and/or a (e.g., any suitable) combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may include methyl acetate, ethyl acetate, n-propyl acetate, dimethylacetate, methyl propionate, ethyl propionate, propyl propionate, decanolide, mevalonolactone, valerolactone, caprolactone, and/or the like

The ether-based solvent may include dibutyl ether, tetraglyme, diglyme, dimethoxyethane, 2-methyltetrahydrofuran, 2,5-dimethyltetrahydrofuran, tetrahydrofuran, and/or the like. The ketone-based solvent may include cyclohexanone and/or the like. The alcohol-based solvent may include ethyl alcohol, isopropyl alcohol, and/or the like, and the aprotic solvent may include nitriles (such as R—CN (wherein R is a C2 to C20 linear, branched, or cyclic hydrocarbon group, a double bond, an aromatic ring, or an ether group)), amides (such as dimethylformamide), dioxolanes (such as 1,3-dioxolane and/or 1,4-dioxolane), sulfolanes, and/or the like.

The non-aqueous organic solvent may be utilized alone or in combination of two or more.

In the latter case, the non-aqueous organic solvent may include a carbonate-based solvent and a propionate-based solvent.

The propionate-based solvent may be included in an amount of greater than or equal to about 70 volume % based on a total amount of 100 volume % the non-aqueous organic solvent. In this case, high-voltage and/or high-temperature characteristics of the rechargeable lithium battery can be improved.

For example, the non-aqueous organic solvent may be a mixed solvent of ethylene carbonate (EC), propylene carbonate (PC), and propyl propionate (PP).

### Lithium Salt

The lithium salt dissolved in the organic solvent supplies lithium ions in a battery, enables (or facilitates) a basic operation of a rechargeable lithium battery, and improves transportation of the lithium ions between positive and negative electrodes. LiPF₆ may be utilized as the lithium salt, and its structure can be stabilized by the second additive.

A concentration of the lithium salt may be about 0.1 M to about 2.0 M.

### Rechargeable Lithium Battery

Some embodiments of the present disclosure provide a rechargeable lithium battery including a positive electrode including a positive electrode active material; a negative electrode including a negative electrode active material; and the electrolyte.

Because the rechargeable lithium battery according to one or more embodiments includes the electrolyte of the present embodiments, high-voltage and/or high-temperature characteristics may be improved.

Hereinafter, descriptions that overlap with the above will be omitted (e.g., will not be provided), and a rechargeable lithium battery according to one or more embodiments will be described in more detail.

### Active Mass Density of Negative Electrode

Comparable rechargeable lithium batteries may utilize a negative electrode with an active mass density of less than about 1.7 g/cc, but a rechargeable lithium battery according to one or more embodiments of the present disclosure utilizes a negative electrode with a mixture density of greater than or equal to about 1.7 g/cc.

The upper limit for the active mass density of the negative electrode is not particularly limited, but may be less than or equal to about 2.0 g/cc, less than or equal to about 1.9 g/cc, or less than or equal to about 1.8 g/cc.

### Charge Upper Limit Voltage

As the rechargeable lithium battery according to one or more embodiments includes the electrolyte of the present embodiments, an increase in battery thickness and a decrease in cycle-life can be suppressed or reduced even at relatively high voltage.

For example, the rechargeable lithium battery may have an upper charge limit voltage of greater than or equal to about 4.5 V.

### Positive Electrode Active Material

The positive electrode active material may be a compound (lithiated intercalation compound) capable of intercalating and deintercallating lithium. For example, one or more types (kinds) of composite oxides of lithium and a metal selected from among cobalt, manganese, nickel, and combinations (e.g., any suitable combination) thereof may be utilized.

The composite oxide may be a lithium transition metal composite oxide, and non-limiting examples may include lithium nickel-based oxide, lithium cobalt-based oxide, lithium manganese-based oxide, a lithium iron phosphate-based compound, cobalt-free lithium nickel-manganese-based oxide, and/or a (e.g., any suitable) combination thereof.

As an example, a compound represented by any of (e.g., any one selected from among) the following chemical formulae may be utilized. LiₐA_{1-b}XbO_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GeO₂ (0.90≤a≤1.8, 0≤b≤0.9, 0≤c≤0.5, 0≤d≤0.5, 0≤e≤0.1); LiₐNiG_{b}O₂(0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and/or LiₐFePO₄ (0.90≤a≤1.8).

In the above chemical formulae, A may be Ni, Co, Mn, and/or a (e.g., any suitable) combination thereof; X may be Al, Ni, Co, Mn, Cr, Fe, Mg, Sr, V, a rare earth element, and/or a (e.g., any suitable) combination thereof; D may be 0, F, S, P, and/or a (e.g., any suitable) combination thereof; G may be Al, Cr, Mn, Fe, Mg, La, Ce, Sr, V, and/or a (e.g., any suitable) combination thereof; and L¹ may be Mn, Al, and/or a (e.g., any suitable) combination thereof.

As an example, the positive electrode active material may have a nickel content (e.g., amount) of greater than or equal to about 80 mol %, greater than or equal to about 85 mol %, greater than or equal to about 90 mol %, greater than or equal to about 91 mol %, or greater than or equal to about 94 mol % based on 100 mol % of metals excluding lithium in the lithium transition metal composite oxide, and may be a high nickel-based positive electrode active material of less than or equal to about 99 mol %. The high-nickel-based positive electrode active materials can achieve relatively high capacity and can be applied to high-capacity, high-density rechargeable lithium batteries.

The positive electrode active material may be, for example, lithium nickel-based oxide represented by Chemical Formula 11, lithium cobalt-based oxide represented by Chemical Formula 12, a lithium iron phosphate-based compound represented by Chemical Formula 13, a cobalt-free lithium nickel manganese-based oxide represented by Chemical Formula 14, and/or a (e.g., any suitable) combination thereof.

Liₐ₁Niₓ₁M¹_{y1}M²_{z1}O_{2-b1}X_{b1}. Chemical Formula 11

In Chemical Formula 11, 0.9≤a1≤1.8, 0.3≤x1≤1, 0≤y1≤0.7, 0≤z1≤0.7, 0.9≤x1+y1+z1≤1.1, and 0≤b1≤0.1, M¹ and M² may each independently be one or more elements selected from among Al, B, Ba, Ca, Ce, Co, Cr, Cu, Fe, Mg, Mn, Mo, Nb, Si, Sn, Sr, Ti, V, W, and Zr, and X may be one or more elements selected from among F, P, and S.

In Chemical Formula 11, 0.6≤x1≤1, 0≤y1≤0.4, and 0≤z1≤0.4, or 0.8≤x1≤1, 0≤y1≤0.2, and 0≤z1≤0.2.

Liₐ₂Coₓ₂M³_{y2}O_{2-b2}X_{b2}. Chemical Formula 12

In Chemical Formula 12, 0.9≤a2≤1.8, 0.7≤x2≤1, 0≤y2≤0.3, 0.9≤x2+y2≤1.1, and 0≤b2≤0.1, M³ may be one or more elements selected from among Al, B, Ba, Ca, Ce, Cr, Cu, Fe, Mg, Mn, Mo, Ni, Se, Si, Sn, Sr, Ti, V, W, Y, Zn, and Zr, and X may be one or more elements selected from among F, P, and S.

Liₐ₃Feₓ₃M⁴_{y3}PO_{4-b3}X_{b3}. Chemical Formula 13

In Chemical Formula 13, 0.9≤a3≤1.8, 0.6≤x3≤1, 0≤y3≤0.4, and 0≤b3≤0.1, M⁴ may be one or more elements selected from among Al, B, Ba, Ca, Ce, Co, Cr, Cu, Mg, Mn, Mo, Ni, Se, Si, Sn, Sr, Ti, V, W, Y, Zn, and Zr, and X may be one or more elements selected from among F, P, and S.

Liₐ₄Niₓ₄Mn_{y4}M⁵_{z4}O_{2-b4}X_{b4}. Chemical Formula 14

In Chemical Formula 14, 0.9≤a4≤1.8, 0.8≤x4<1, 0<y4≤0.2, 0≤z4≤0.2, 0.9≤x4+y4+z4≤1.1, and 0≤b4≤0.1 M⁵ may be one or more elements selected from among Al, B, Ba, Ca, Ce, Cr, Fe, Mg, Mo, Nb, Si, Sn, Sr, Ti, V, W, and Zr, and X may be one or more elements selected from among F, P, and S.

For example, the electrolyte of the present embodiments can significantly improve high-voltage and/or high-temperature characteristics of a battery utilizing the lithium cobalt-based oxide represented by Chemical Formula 12.

### Positive Electrode

The positive electrode for a rechargeable lithium battery may include a current collector and a positive electrode active material layer on the current collector. The positive electrode active material layer may include a positive electrode active material and may further include a binder and/or a conductive material.

For example, the positive electrode may further include an additive that can function as a sacrificial positive electrode.

A content (e.g., amount) of the positive electrode active material may be about 90 wt % to about 99.5 wt %, and a content (e.g., amount) of the binder and the conductive material may be about 0.5 wt % to about 5 wt %, respectively based on 100 wt % of the positive electrode active material layer.

The binder serves to attach the positive electrode active material particles well or suitably to each other and also to attach the positive electrode active material well or suitably to the current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and/or the like, as non-limiting examples.

The conductive material may be utilized to impart conductivity (e.g., electrical conductivity) to the electrode. Any suitable material that does not cause chemical change (e.g., does not cause an undesirable chemical change in the rechargeable lithium battery) and suitably conducts electrons can be utilized in the battery. Examples of the conductive material may include a carbon-based material such as natural graphite, artificial graphite, carbon black, acetylene black, ketjen black, a carbon fiber, a carbon nanofiber, and/or carbon nanotube; a metal-based material containing copper, nickel, aluminum, silver, and/or the like, in a form of a metal powder or a metal fiber; a conductive polymer such as a polyphenylene derivative; and/or a (e.g., any suitable) mixture thereof.

Al may be utilized as the current collector, but the present disclosure is not limited thereto.

### Negative Electrode Active Material

The negative electrode active material may be a material that can reversibly intercalate/deintercalate lithium ions, a lithium metal, a lithium metal alloy, a material capable of doping and dedoping lithium, and/or a transition metal oxide.

The material that reversibly intercalates/deintercalates lithium ions may include a carbon-based negative electrode active material, for example, crystalline carbon, amorphous carbon and/or a (e.g., any suitable) combination thereof. The crystalline carbon may be graphite such as non-shaped, sheet-shaped, flake-shaped, sphere-shaped, and/or fiber-shaped natural graphite and/or artificial graphite. The amorphous carbon may be a soft carbon, a hard carbon, a mesophase pitch carbonization product, calcined coke, and/or the like.

The lithium metal alloy may include lithium and a metal selected from among Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material and/or a Sn-based negative electrode active material. The Si-based negative electrode active material may include silicon, a silicon-carbon composite, SiOₓ (0<x≤2), a Si-Q alloy (where Q is selected from among an alkali metal, an alkaline-earth metal, a Group 13 element, a Group 14 element (excluding Si), a Group 15 element, a Group 16 element, a transition metal, a rare earth element, and/or a (e.g., any suitable) combination thereof). The Sn-based negative electrode active material may include Sn, SnOₓ (0<x≤2) (e.g., SnO₂), a Sn-based alloy, and/or a (e.g., any suitable) combination thereof.

The silicon-carbon composite may be a composite of silicon and amorphous carbon. According to one or more embodiments, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be utilized in combination with a carbon-based negative electrode active material.

### Negative Electrode

A negative electrode for a rechargeable lithium battery includes a current collector and a negative electrode active material layer on the current collector. The negative electrode active material layer includes a negative electrode active material and may further include a binder and/or a conductive material.

For example, the negative electrode active material layer may include about 90 wt % to about 99 wt % of the negative electrode active material, about 0.5 wt % to about 5 wt % of the binder, and about 0.5 wt % to about 5 wt % of the conductive material.

The binder may serve to attach the negative electrode active material particles well or suitably to each other and also to attach the negative electrode active material well or suitably to the current collector. The binder may include a non-aqueous binder, an aqueous binder, a dry binder, and/or a (e.g., any suitable) combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, and/or a (e.g., any suitable) combination thereof.

The aqueous binder may be selected from among a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and/or a (e.g., any suitable) combination thereof.

When an aqueous binder is utilized as the negative electrode binder, it may further include a cellulose-based compound capable of imparting viscosity. The cellulose-based compound includes one or more of carboxymethyl cellulose, hydroxypropylmethyl cellulose, methyl cellulose, or alkali metal salts thereof. The alkali metal may be Na, K, and/or Li.

The dry binder may be a polymer material capable of being fiberized, and may be, for example, polytetrafluoroethylene, polyvinylidene fluoride, polyvinylidene fluoride-hexafluoropropylene copolymer, polyethylene oxide, and/or a (e.g., any suitable) combination thereof.

The conductive material is included to provide suitable electrode conductivity, and any suitable electrically conductive material may be utilized as a conductive material unless it causes an undesirable chemical change in the battery. Examples of the conductive material may be a carbon-based material such as natural graphite, artificial graphite, carbon black, acetylene black, ketjen black, a carbon fiber, a carbon nanofiber, a carbon nanotube, and/or the like; a metal-based material such as copper, nickel, aluminum silver, and/or the like in a form of a metal powder or a metal fiber; a conductive polymer such as a polyphenylene derivative; and/or a (e.g., any suitable) mixture thereof.

The negative electrode current collector may include one (e.g., any) selected from among a copper foil, a nickel foil, a stainless steel foil, a titanium foil, a nickel foam, a copper foam, a polymer substrate coated with a conductive metal, and/or a (e.g., any suitable) combination thereof, but the present disclosure is not limited thereto.

### Separator

Depending on the type or kind of the rechargeable lithium battery, a separator may be present between the positive electrode and the negative electrode. The separator may include polyethylene, polypropylene, polyvinylidene fluoride, or may be a multilayer film of two or more layers thereof, for example, a mixed multilayer film such as a polyethylene/polypropylene two-layer separator, polyethylene/polypropylene/polyethylene three-layer separator, polypropylene/polyethylene/polypropylene three-layer separator, and/or the like.

The separator may include a porous substrate and a coating layer including an organic material, an inorganic material, and/or a (e.g., any suitable) combination thereof on one or both surfaces (e.g., opposite surfaces) of the porous substrate.

The porous substrate may be a polymer film formed of any one or more selected from among polymer polyolefin (such as polyethylene and/or polypropylene), polyester (such as polyethylene terephthalate and/or polybutylene terephthalate), polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, polytetrafluoroethylene (e.g., TEFLON®), a copolymer of two or more thereof, and a mixture of two or more thereof.

The organic material may include a polyvinylidene fluoride-based polymer and/or a (meth)acrylic-based polymer.

The inorganic material may include inorganic particles selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and/or a (e.g., any suitable) combination thereof, but the present disclosure is not limited thereto.

The organic material and the inorganic material may be mixed in one coating layer, or a coating layer including an organic material and a coating layer including an inorganic material may be stacked.

### Rechargeable Lithium Battery

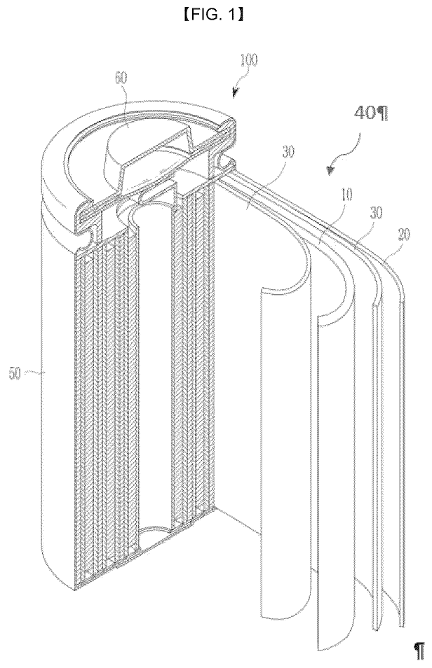

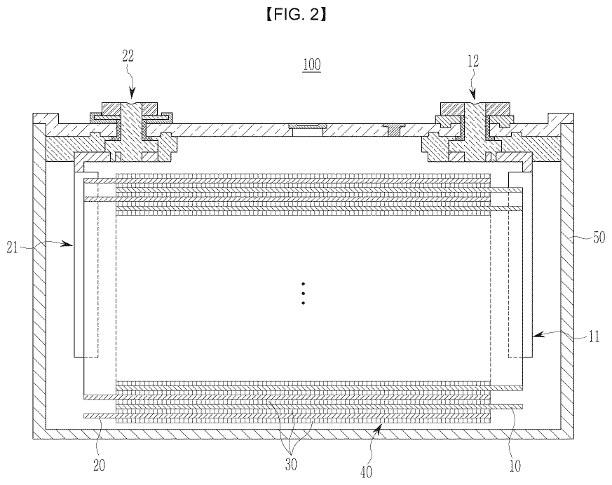

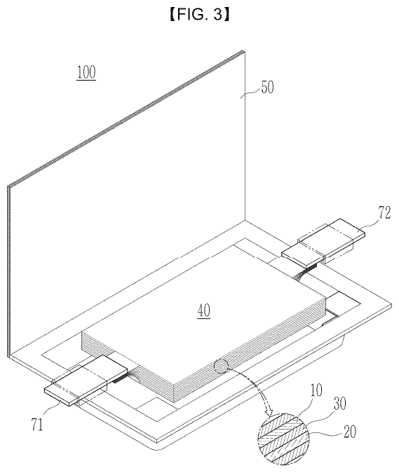

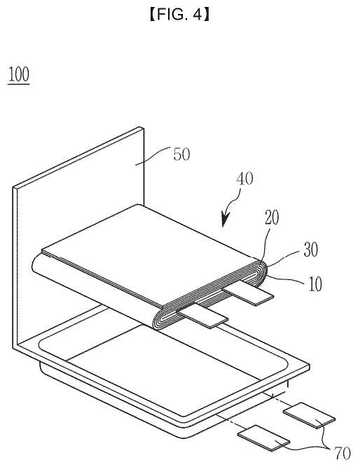

The rechargeable lithium battery may be classified into a cylindrical, a prismatic, a pouch, and/or a coin-type or kind battery, and/or the like depending on its shape. FIGS. 1 to 4 are schematic views illustrating rechargeable lithium batteries according to one or more embodiments. FIG. 1 shows a cylindrical battery, FIG. 2 shows a prismatic battery, and FIGS. 3 and 4 show pouch-type or kind batteries. Referring to FIGS. 1 to 4, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte. The rechargeable lithium battery 100 may include a sealing member 60 sealing the case 50 (as shown in FIG. 1). In FIG. 2, the rechargeable lithium battery 100 may include a positive lead tab 11, a positive terminal 12, a negative lead tab 21, and a negative terminal 22. As shown in FIGS. 3 and 4, the rechargeable lithium battery 100 may include an electrode tab 70, which may be, for example, a positive electrode tab 71 and a negative electrode tab 72 serving as an electrical path for inducing the current formed in the electrode assembly 40 to the outside.

The rechargeable lithium battery according to one or more embodiments may be applied to automobiles, mobile phones, and/or one or more suitable types (kinds) of electrical devices, but the present disclosure is not limited thereto.

Hereinafter, examples of the present disclosure and comparative examples are described. These examples, however, are not in any sense to be interpreted as limiting the scope of present disclosure.

### EXAMPLES AND COMPARATIVE EXAMPLES

Electrolytes and Rechargeable Lithium Battery Cells were Prepared as Follows.

### Example 1

### (1) Preparation of Electrolyte

1.3 M LiPF₆ was dissolved in a non-aqueous organic solvent in which ethylene carbonate (EC), propylene carbonate (PC), and propyl propionate (PP) were mixed in a volume ratio of 10:15:75, and 1 wt % of the first additive and 1 wt % of the second additive were added thereto to prepare an electrolyte.

The first additive represented by Chemical Formula 1-1-1 (perfluoro(2-methyl-3-pentanone) (CAS No.: 756-13-8)) was utilized, and the second additive represented by Chemical Formula 2-1 (lithium difluoro(oxalato)borate (LiDFOB, CAS No.: 409071-16-5)) was utilized:

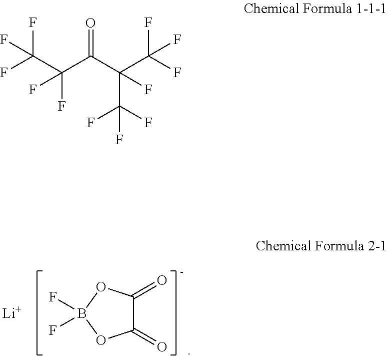

### (2) Manufacture of Rechargeable Lithium Battery Cells

LiCoO₂ as a positive electrode active material, polyvinylidene fluoride as a binder, and acetylene black as a conductive material were mixed respectively in a weight ratio of 96:3:1, and then, dispersed in N-methyl pyrrolidone to prepare positive electrode active material slurry.

The positive electrode active material slurry was coated on a 15 μm-thick Al foil, dried at 100° C., and pressed to manufacture a positive electrode.

Artificial graphite as a negative electrode active material, a styrene-butadiene rubber binder, and carboxymethyl cellulose in a weight ratio of 98:1:1 were dispersed in distilled water to prepare negative electrode active material slurry.

The negative electrode active material slurry was coated on a 10 μm-thick Cu foil, dried at 100° C., and pressed to manufacture a negative electrode. At this time, an active mass density of the negative electrode was set to 1.7 g/cc.

An electrode assembly was manufactured by assembling the positive electrode, the negative electrode, and a separator made of polyethylene with a thickness of 10 μm, and the electrolyte was injected, to manufacture a rechargeable lithium battery cell.

### Example 2

An electrolyte and a rechargeable lithium battery cell were manufactured in substantially the same manner as in Example 1 except that 3 wt % of the first additive and 1 wt % of the second additive were utilized to prepare the electrolyte.

### Example 3

An electrolyte and a rechargeable lithium battery cell were manufactured in substantially the same manner as in Example 1 except that 2 wt % of the first additive and 0.5 wt % of the second additive were utilized to prepare the electrolyte.

### Example 4

An electrolyte and a rechargeable lithium battery cell were manufactured in substantially the same manner as in Example 1 except that 2 wt % of the first additive and 2 wt % of the second additive were utilized to prepare the electrolyte.

### Example 5

An electrolyte and a rechargeable lithium battery cell were manufactured in substantially the same manner as in Example 1 except that 2 wt % of the first additive and 1 wt % of the second additive were utilized to prepare the electrolyte.

### Comparative Example 1

An electrolyte and a rechargeable lithium battery cell were manufactured in substantially the same manner as in Example 1 except that the additives were not added at all to prepare the electrolyte.

### Comparative Example 2

An electrolyte and a rechargeable lithium battery cell were manufactured in substantially the same manner as in Example 1 except that 1 wt % of the second additive alone was utilized without adding the first additive to prepare the electrolyte.

### Comparative Example 3

An electrolyte and a rechargeable lithium battery cell were manufactured in substantially the same manner as in Example 1 except that 2 wt % of the second additive alone as utilized without adding the second additive to prepare the electrolyte.

### Evaluation Examples

The negative electrode and rechargeable lithium battery cell were evaluated in the following manner.

### Evaluation 1: Evaluation of Room-Temperature Charge and Discharge Cycle Characteristics

The rechargeable lithium battery cells were charged and discharged 400 times under the conditions of 25° C., 2.0 C charge (CC/CV, 4.53 V, 0.025 C Cut-off)/1.0 C discharge (CC, 3V Cut-off).

The thickness increase rates were calculated according to Equation 1, capacity retention rates were calculated according to Equation 2, and the results are shown in Table 1.

$$Thickness increase rate = \qquad Equation 1$$

$$\{ ( Full charge thickness after 400 cycles ) -$$

$$( Full charge thickness after 1 cycle ) \} /$$

$$( Full charge thickness after 1 cycle ) * 100$$

In Equation 1 above, “full charge thickness” refers to a thickness of the rechargeable lithium battery cells measured after charging at SOC 100% (state of charge 100%) (if (e.g., when) the total charge capacity of the battery is set at 100%, charged to 100% charge capacity) after each cycle.

$$Capacity retention rate = \qquad Equation 2$$

$$( discharge capacity after 400 cycles / discharge capacity after 1 cycle ) * 100$$

TABLE 1

| | Additive | | Room-temperature | |
|---|---|---|---|---|
| | content | | charge and discharge | |
| | (e.g., amount) in | | characteristics of rechargeable | |
| | electrolyte (wt %) | | lithium battery cells | |
| | First | Second | Thickness | Capacity |
| | additive | additive | increase rate (%) | retention rate (%) |
| Comparative | 0 | 0 | 17.1 | 82.9 |
| Example 1 | | | | |
| Comparative | 0 | 1 | 15.5 | 83.6 |
| Example 2 | | | | |
| Comparative | 2 | 0 | 14.3 | 84.8 |
| Example 3 | | | | |
| Example 1 | 1 | 1 | 9.1 | 86.9 |
| Example 2 | 3 | 1 | 11.5 | 85.2 |
| Example 3 | 2 | 0.5 | 8.5 | 87.5 |
| Example 4 | 2 | 2 | 10.2 | 86.1 |
| Example 5 | 2 | 1 | 5.6 | 89.2 |

### Evaluation 2: Evaluation of Storage Characteristics at High Temperature

The rechargeable lithium battery cells before being stored at a relatively high temperature were measured with respect to initial DC internal resistance (initial Dr-IR) by ΔV/ΔI (voltage change/current change).

After making a maximum energy state inside the rechargeable lithium battery cells lithium battery to a full-charge state (SOC 100%) and then, storing the cells at a relatively high temperature (60° C.) for 30 days in this state, the cells were measured with respect to DC resistance (D_{c}-IR after 30 days).

A DC-IR increase rate was calculated according to Equation 3, and the results are shown in Table 2.

$$DCIR increase rate = ( DC - IR after 30 days ) / ( initial DC - IR ) * 100 \qquad Equation 3$$

TABLE 2

| | Additive | | Storage characteristics |
|---|---|---|---|
| | content (e.g., | | at relatively |
| | amount) in | | high temperature |
| | electrolyte | | of rechargeable lithium |
| | (wt %) | | battery cells |
| | First | Second | DC-IR increase |
| | additive | additive | rate (%) |
| Comparative | 0 | 0 | 38.4 |
| Example 1 | | | |
| Comparative | 0 | 1 | 31.2 |
| Example 2 | | | |
| Comparative | 2 | 0 | 30.3 |
| Example 3 | | | |
| Example 1 | 1 | 1 | 17.2 |
| Example 2 | 3 | 1 | 24.1 |
| Example 3 | 2 | 0.5 | 14.1 |
| Example 4 | 2 | 2 | 22.5 |
| Example 5 | 2 | 1 | 10.2 |

### SUMMARY

Referring to Tables 1 and 2, the electrolytes (Examples 1 to 5) concurrently (e.g., simultaneously) including the first and the second additives exhibited improved high voltage and high temperature characteristics of the rechargeable lithium battery cells, compared with the electrolyte including no additives at all (Comparative Example 1) and the electrolyte including one type or kind of additive out of the two types (kinds) of additives (Comparative Examples 2 and 3).

The electrolytes concurrently (e.g., simultaneously) including the first and second additives (Examples 1 to 5) suppressed or reduced an increase in a thickness, even if the rechargeable lithium battery cells were charged and discharged under a relatively high voltage condition, and improved cycle-life of the cells.

In addition, the electrolytes concurrently (e.g., simultaneously) including the first and second additives (Examples 1 to 5) suppressed or reduced an increase in resistance, even if the rechargeable lithium battery cells were stored at a relatively high temperature.

According to the present embodiments, in the electrolytes concurrently (e.g., simultaneously) including the first and second additives (Examples 1 to 5), a content (e.g., amount) of each of the additives and a mixing ratio thereof may be controlled or selected according to desired or suitable characteristics.

While this invention has been described in connection with what is presently considered to be example embodiments, it is to be understood that present disclosure is not limited to the disclosed embodiments, but, on the contrary, is intended to cover one or more suitable modifications and equivalent arrangements included within the spirit and scope of the appended claims and their equivalents.

### REFERENCE NUMERALS

100: rechargeable lithium battery
10: positive electrode
11: positive electrode lead tab
12: positive terminal
20: negative electrode
21: negative electrode lead tab
22: negative terminal
30: separator
40: electrode assembly
50: case
60: sealing member
70: electrode tab
71: positive electrode tab
72: negative electrode tab

What is claimed is:

1. An electrolyte comprising:
a lithium salt;
a non-aqueous organic solvent;
a first additive represented by Chemical Formula 1; and
a second additive represented by Chemical Formula 2: 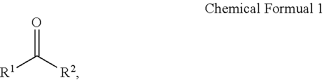
in Chemical Formula 1,
R¹ and R² are each independently a fluorine atom or a C1 to C10 fluoroalkyl group; 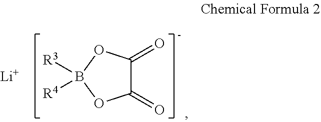
in Chemical Formula 2,
R³ and R⁴ are each independently a halogen atom or a C1 to C10 fluoroalkyl group,
wherein the electrolyte is for a rechargeable lithium battery.

2. The electrolyte as claimed in claim 1, wherein
the first additive is represented by Chemical Formula 1-1: 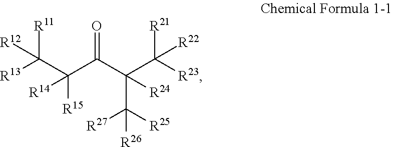
in Chemical Formula 1-1,
R¹¹ to R¹⁵ are each a hydrogen atom or a fluorine atom, provided that at least one of R¹¹ to R¹⁵ is a fluorine atom; and
R²¹ to R²⁷ are each a hydrogen atom or a fluorine atom, provided that at least one of R²¹ to R²⁷ is a fluorine atom.

3. The electrolyte as claimed in claim 1, wherein
the first additive is represented by Chemical Formula 1-1-1:

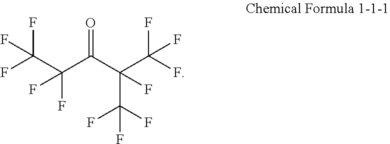 [SMILES: O=C(C(F)(F)C(F)(F)F)C(F)(C(F)(F)F)C(F)(F)F]

4. The electrolyte as claimed in claim 1, wherein
both R³ and R⁴ are fluorine atoms.

5. The electrolyte as claimed in claim 1, wherein
the first additive is in an amount of about 0.1 to about 10 wt % based on a total amount of 100 wt % the electrolyte.

6. The electrolyte as claimed in claim 1, wherein
the second additive is in an amount of about 0.1 to about 5 wt % based on a total amount of 100 wt % the electrolyte.

7. The electrolyte as claimed in claim 1, wherein
a weight ratio of the first additive and the second additive is about 1:5 to about 10:1.

8. The electrolyte as claimed in claim 1, wherein
the non-aqueous organic solvent comprises a carbonate-based solvent and a propionate-based solvent.

9. The electrolyte as claimed in claim 8, wherein
the propionate-based solvent is in an amount of greater than or equal to about 70 volume % based on a total amount of 100 volume % of the non-aqueous organic solvent.

10. The electrolyte as claimed in claim 1, wherein
the lithium salt is LiPF₆.

11. The electrolyte as claimed in claim 1, wherein
the lithium salt is in a concentration of about 0.1 M to about 2.0 M.

12. A rechargeable lithium battery, comprising
a positive electrode comprising a positive electrode active material;
a negative electrode comprising a negative electrode active material; and
the electrolyte as claimed in claim 1.

13. The rechargeable lithium battery as claimed in claim 12, wherein
the positive electrode active material comprises lithium nickel-based oxide, lithium cobalt-based oxide, lithium manganese-based oxide, a lithium iron phosphate-based compound, cobalt-free lithium nickel-manganese-based oxide, or a combination thereof.

14. The rechargeable lithium battery as claimed in claim 12, wherein
the negative electrode active material comprises a carbon-based negative electrode active material, a Si-based negative electrode active material, or a combination thereof.

15. The rechargeable lithium battery as claimed in claim 12, wherein
the rechargeable lithium battery has an upper charge limit voltage of greater than or equal to about 4.5 V.
